(19) United States
(12) Patent Application Publication
(10) Pub. No.: US 2026/0285720 A1
(43) Pub. Date: Sep. 24, 2026

(54) WATER TREATMENT APPARATUS AND WATER TREATMENT METHOD

(71) Applicant: ORGANO CORPORATION, Tokyo (JP)

(72) Inventors: Takefumi SEKINE, Tokyo (JP); Takuma OGAWA, Tokyo (JP)

(73) Assignee: ORGANO CORPORATION, Tokyo (JP)

(21) Appl. No.: 19/479,893

(22) PCT Filed: Apr. 1, 2024
(86) PCT No.: PCT/JP2024/013517

§ 371 Date: Oct. 29, 2025

(30) Foreign Application Priority Data
May 2, 2023 (JP) 2023-076090

(51) Int. Cl. C02F 1/76; C02F 1/00; C02F 1/68; C02F 101/38; C02F 103/04; C02F 103/34

(52) U.S. Cl. CPC C02F 1/766; C02F 1/008; C02F 1/686; C02F 2101/38; C02F 2103/04; C02F 2103/346; C02F 2209/02; C02F 2209/29; C02F 2209/40

(57) ABSTRACT

Water treatment apparatus includes treatment tank for storing water to be treated, inflow channels for allowing the water to be treated to flow into treatment tank, chemical injector that injects a chemical including a chlorine-based oxidizing agent and a bromide salt into the water to be treated flowing into treatment tank through one inflow channel of inflow channels to decompose urea contained in the water to be treated in treatment tank, flow detectors that detect the flow rates of the water to be treated through inflow channels into treatment tank, and controller that adjusts the amount of chemical to be injected into the water to be treated by chemical injector based on the detection results from flow detectors and the target concentration of the chemical in treatment tank.

### TECHNICAL FIELD

The present invention relates to a water treatment apparatus and a water treatment method.

### BACKGROUND ART

In the manufacturing process of electronic devices such as semiconductors, ultrapure water from which impurities are highly removed is used for various purposes such as cleaning. Total organic carbon (TOC) contained in ultrapure water is a factor that reduces device yield, and therefore its concentration must be strictly controlled. Ultrapure water is generally produced by sequentially treating raw water, such as city water, in a pretreatment system, a primary pure water system, and a secondary pure water system (i.e. subsystem), and to reduce TOC in ultrapure water, it is important to remove urea from raw water during pretreatment. The reason is that urea is difficult to remove by any of the units included in the primary pure water system and subsystem (e.g., reverse osmosis membrane unit, ion exchange unit, UV oxidation unit) and may leak into the ultrapure water, increasing the TOC concentration.

Patent Literature 1 discloses a method for removing urea from raw water. In this method, a chlorine-based oxidizing agent (such as sodium hypochlorite) and a bromide salt (such as sodium bromide) are injected as chemicals into raw water, and the raw water is retained in a reaction tank, whereby the urea is decomposed and removed. Patent Literature 1 also discloses a technique including detecting the urea concentration in the raw water to be supplied to the reaction tank and adjusting the amounts of chemicals to be injected into the raw water based on the detection results.

### CITATION LIST

### Patent Literature

Patent Literature 1: JP 09-094585 A

### SUMMARY OF INVENTION

### Technical Problem

To ensure that the urea decomposition reaction described above proceeds as necessary and sufficient, it is important to adjust the chemical concentrations in the reaction tank to the desired target concentrations. However, even if the technique disclosed in Patent Literature 1 is used to adjust the amounts of chemicals to be injected into the raw water, it is difficult to adjust the chemical concentrations in the reaction tank to the target concentrations if water other than the raw water flows into the reaction tank. As a result, there is concern that insufficient injection of the chemicals may cause the urea to leak into the ultrapure water without being fully treated, or excessive injection of the chemicals may cause pipe corrosion and increased running costs.

It is therefore an object of the present invention to provide a water treatment apparatus and a water treatment method that can optimize the amount of chemical to be injected that is required for urea decomposition.

### Solution to Problem

To achieve the above object, a water treatment apparatus of the present invention includes: a treatment tank for storing water to be treated; a plurality of inflow channels for allowing the water to be treated to flow into the treatment tank; a chemical injector that injects a chemical including a chlorine-based oxidizing agent and a bromide salt into the water to be treated flowing into the treatment tank through one inflow channel of the plurality of inflow channels to decompose urea contained in the water to be treated in the treatment tank; a plurality of flow detectors that detect flow rates of the water to be treated flowing into the treatment tank through the plurality of inflow channels; and a controller that adjusts an amount of the chemical to be injected into the water to be treated by the chemical injector based on detection results from the plurality of flow detectors and a target concentration of the chemical in the treatment tank.

In addition, a water treatment method of the present invention includes: allowing water to be treated to flow into a treatment tank through a plurality of inflow channels; and injecting a chemical including a bromide salt and a chlorine-based oxidizing agent into the water to be treated flowing into the treatment tank through one inflow channel of the plurality of inflow channels to decompose urea contained in the water to be treated in the treatment tank, wherein the injecting includes: detecting flow rates of the water to be treated flowing into the treatment tank through the plurality of inflow channels; and adjusting an amount of the chemical to be injected into the water to be treated based on the detected flow rates and a target concentration of the chemical in the treatment tank.

According to the water treatment apparatus and the water treatment method, even when the flow rate of the water to be treated flowing into the treatment tank fluctuates, the chemical can be injected into the water to be treated without excess or deficiency accordingly.

### Advantageous Effects of Invention

As described above, according to the present invention, the amount of chemical to be injected that is required for urea decomposition can be optimized.

### BRIEF DESCRIPTION OF DRAWINGS

FIG. 1 is a schematic diagram of a water treatment apparatus according to a first embodiment of the present invention;

FIG. 2 is a schematic diagram showing a variant of the water treatment apparatus according to the first embodiment of the present invention; and

FIG. 3 is a schematic diagram of a water treatment apparatus according to a second embodiment of the present invention.

### DESCRIPTION OF EMBODIMENTS

Embodiments of the present invention will be described below with reference to the drawings. Although a water treatment apparatus of the present invention is exemplified as being used for urea treatment in a pretreatment system of an ultrapure water production system, the applications thereof are not limited thereto. The water treatment apparatus of the present invention may be used, for example, in a primary pure water system or subsystem of the ultrapure water production system, or in a recovery system for recovery and reuse of ultrapure water that has been used for cleaning or other purposes.

### First Embodiment

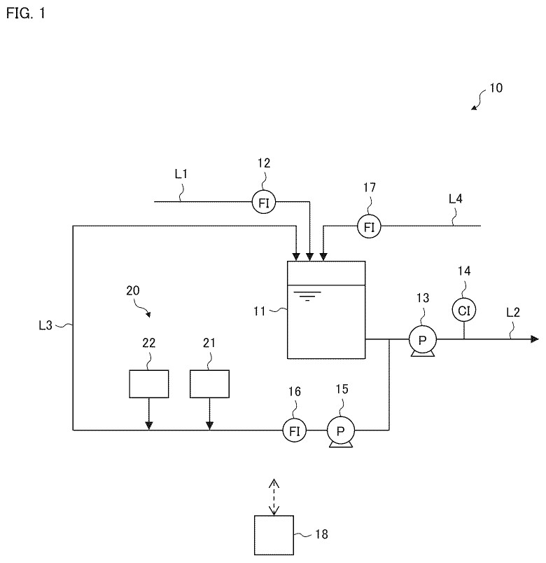

FIG. 1 is a schematic diagram of a water treatment apparatus according to a first embodiment of the present invention. It goes without saying that the illustrated configuration of the water treatment apparatus is merely an example and may be modified as needed according to the purpose of use, application, and required performance of the apparatus.

Water treatment apparatus 10 includes raw water tank 11 for storing raw water, such as city water, and several lines L1-L4 connected to raw water tank 11. Several lines L1-L4 consist of raw water line L1 for supply of raw water to raw water tank 11, supply line L2 for supply of the raw water in raw water tank 11 to the primary pure water system (not shown), circulation line L3 for circulation of the raw water in raw water tank 11, and return line L4 for return of return water from the primary pure water system (e.g., concentrate water from a reverse osmosis membrane unit) to raw water tank 11.

Raw water tank 11 functions as a treatment tank for urea decomposition treatment to decompose urea contained in the raw water, as described in detail below. Therefore, the water to be treated, which is subjected to the urea decomposition treatment in raw water tank 11, includes not only the raw water supplied through raw water line L1, but also the return water returned from the primary pure water system through return line L4. For this reason, raw water line L1 functions as a first inflow channel for allowing such water to be treated to flow from the outside into raw water tank 11, and return line L4 also functions as the first inflow channel for allowing the water to be treated to flow from the outside into raw water tank 11. On the other hand, circulation line L3 functions as a second inflow channel for allowing the water to be treated in raw water tank 11 to flow out and to flow again into raw water tank 11. Hereinafter, the water stored in raw water tank 11 is collectively referred to as water to be treated, of which the water circulating through circulation line L3 is also referred to as circulating water and the water flowing out through supply line L2 is also referred to as treated water.

Water treatment apparatus 10 also includes raw water flowmeter 12 installed in raw water line L1, water pump 13 and residual chlorine meter 14 that are installed in supply line L2, circulation pump 15 and circulating water flowmeter 16 that are installed in circulation line L3, and return water flowmeter 17 installed in return line L4.

Raw water flowmeter 12 functions as a first flow detector that detects the flow rate of the water to be treated flowing into raw water tank 11 through raw water line L1. Water pump 13 functions to allow the water to be treated to flow out of raw water tank 11 so as to supply it to the primary pure water system, and residual chlorine meter 14 functions as a concentration detector that detects the residual chlorine concentration in the treated water flowing out of raw water tank 11. Circulation pump 15 functions to allow the water to be treated in raw water tank 11 to flow through circulation line L3, and circulating water flowmeter 16 functions as a second flow detector that detects the flow rate of the water to be treated flowing into raw water tank 11 through circulation line L3. Return water flowmeter 17 functions as the first flow detector that detects the flow rate of the water to be treated flowing into raw water tank 11 through return line L4.

Further, water treatment apparatus 10 includes chemical injector 20 that injects chemicals into the circulating water flowing through circulation line L3 and controller 18 that controls the operation of water treatment apparatus 10, including adjustment of the amounts of chemicals to be injected by chemical injector 20.

Chemical injector 20 is composed of oxidizing agent injector 21 that injects a chlorine-based oxidizing agent into the circulating water and bromide salt injector 22 that injects a bromide salt into the circulating water. Oxidizing agent injector 21 and bromide salt injector 22 are not particularly limited as long as they can continuously inject chemicals into the circulating water, and may each be, for example, a chemical injection pump that injects a chemical stored in a chemical tank into circulation line L3. The location where the chemicals are injected may not be circulation line L3, and may be, for example, raw water line L1. In that case, however, if large flow fluctuations (including flow stoppages) occur in the raw water flowing through raw water line L1, it becomes difficult to inject the chemicals stably, and in some cases, it may even become impossible to inject the chemicals. Therefore, the location where the chemicals are injected is preferably circulation line L3, as illustrated. Examples of the chlorine-based oxidizing agent to be injected by oxidizing agent injector 21 include, for example, sodium hypochlorite, sodium perchlorate, and calcium hypochlorite. Examples of the bromide salt to be injected by bromide salt injector 22 include sodium bromide and potassium bromide, and for example, sodium bromide is preferably used.

When sodium hypochlorite (NaClO) is used as a chlorine-based oxidizing agent and sodium bromide (NaBr) is used as a bromide salt, they first react in raw water tank 11 to form sodium hypobromite (NaBrO). Then, this sodium hypobromite reacts with urea so that the urea is decomposed. Such a urea decomposition reaction is represented by two Equations (1) and (2) as below.

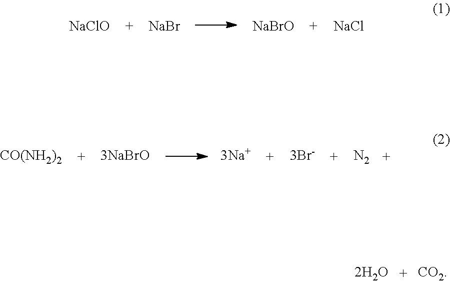

Further, from Equations (1) and (2) described above, Equation (3) as below is derived.

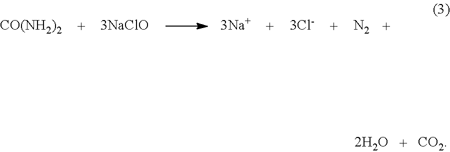

Therefore, according to Equation (3) described above, the sodium bromide concentration does not change and remains substantially constant before and after the urea decomposition reaction.

Controller 18 adjusts the amounts of chemicals to be injected by chemical injector 20 based on the detection results from raw water flowmeter 12, circulating water flowmeter 16, and return water flowmeter 17. The method of adjusting the amounts of chemicals to be injected, executed by controller 18, will be described below by exemplifying the case where sodium hypochlorite and sodium bromide are used as chemicals.

As a precondition, the target concentrations of sodium hypochlorite and sodium bromide in raw water tank 11 have been set in controller 18. If the chemical concentrations in raw water tank 11 are too low, the urea decomposition reaction described above may not proceed sufficiently, resulting in urea leaking into the treated water. On the other hand, if the concentrations are too high, problems such as increased running costs, increased ion load on a downstream ion exchange unit, and pipe corrosion, may occur. Therefore, the respective target concentrations are determined based on the urea concentration in the raw water that has been previously detected, taking these points into consideration. The respective target concentrations of the chemicals may be fine-tuned by monitoring the total organic carbon (TOC) concentration in the ultrapure water finally obtained. In other words, if the TOC concentration in the ultrapure water exceeds the allowable range, the target concentrations of the chemicals may be reset to higher concentrations than the initial target concentrations.

When the adjustment of the amounts of chemicals to be injected by controller 18 is started, the amounts of sodium hypochlorite and sodium bromide to be injected are calculated for the preset target concentrations as described above. Specifically, in the case of sodium hypochlorite, raw water flowmeter 12 detects the flow rate of the raw water flowing through raw water line L1, circulating water flowmeter 16 detects the flow rate of the circulating water flowing through circulating line L3, and return water flowmeter 17 detects the flow rate of the return water flowing through return line L4. Once the flow rates of all the water to be treated flowing into raw water tank 11 are thus detected, the target amount of sodium hypochlorite to be injected to achieve the target concentration is calculated for the total flow rate. Oxidizing agent injector 21 (e.g., the chemical injection pump thereof) is then controlled to inject a determined amount of sodium hypochlorite into the circulating water flowing through circulation line L3.

On the other hand, the adjustment of the amount of sodium bromide to be injected is basically the same as in the case of sodium hypochlorite. However, since the sodium bromide concentration remains substantially constant before and after the urea decomposition reaction as described above, the water flowing out of raw water tank 11, i.e., the circulating water flowing through circulation line L3, also contains the same concentration of sodium bromide as in raw water tank 11. Therefore, to maintain the sodium bromide concentration in raw water tank 11 at the target concentration, it is sufficient to inject sodium bromide in an amount corresponding to the amount of water to be treated flowing into raw water tank 11 through raw water line L1 and return line L4. For this reason, in the case of sodium bromide, the target amount of sodium bromide to be injected to achieve the preset target concentration is calculated for the sum of the values detected by raw water flowmeter 12 and return water flowmeter 17. Bromide salt injector 22 (e.g., the chemical injection pump thereof) is then controlled to inject a determined amount of sodium bromide into the circulating water flowing through circulation line L3.

Thus, in this embodiment, the amounts of chemicals to be injected are calculated based on the flow rates of the water to be treated flowing into raw water tank 11, so that especially when the flow rate of the raw water or return water fluctuates, the chemicals can be injected into the water to be treated without excess or deficiency accordingly. As a result, the amounts of chemicals to be injected that are required for urea decomposition can be optimized and the chemical concentrations in raw water tank 11 can be adjusted to the optimum levels.

The adjustment of the amounts of chemicals to be injected by controller 18 may be performed continuously, and therefore the flow rate for calculating the amounts of chemicals to be injected may be an instantaneous flow rate. However, if instantaneous flow fluctuations occur, such as when the supply of the water to be treated to raw water tank 11 is temporarily stopped, chemical injector 20 may not be stably controlled, causing hunting. Therefore, the adjustment of the amounts of chemicals to be injected by controller 18 is preferably performed regularly at a frequency of once in a predetermined period, and the flow rate for calculating the amounts of chemicals to be injected is preferably the integrated flow rate over that predetermined period. In other words, the respective amounts of chemicals to be injected in the next predetermined period are preferably calculated based on the total amount of water to be treated flowing into raw water tank 11 within the predetermined period since the previous adjustment, i.e., the integrated flow rates detected by flowmeters 12, 16, 17. The predetermined period in this case is not particularly limited, but is preferably set according to the time required for the urea decomposition reaction, i.e., the residence time of the water to be treated in raw water tank 11, and is, for example, several hours to 24 hours. The residence time, as used herein, is defined as the value obtained by dividing the volume corresponding to the maximum water capacity of raw water tank 11 (i.e., the amount of water held when the water level in raw water tank 11 is at a predetermined upper water level) by the sum of the average flow rate of the treated water flowing through supply line L2 and the average flow rate of the circulating water flowing through circulation line L3. Instead of flowmeters 12, 16, 17 each detecting the integrated flow rate, flowmeters 12, 16, 17 may each detect the instantaneous flow rate, which is then integrated by controller 18.

For example, a method to optimize the amount of sodium hypochlorite to be injected could also be to adjust the amount of sodium hypochlorite to be injected based on the residual chlorine concentration in the treated water detected by residual chlorine meter 14. However, in general, the accuracy of detecting the residual chlorine concentration by residual chlorine meter 14 is not very high and is not sufficient to accurately control the amount of sodium hypochlorite to be injected. In addition, the residence time of the water to be treated in raw water tank 11 is relatively long, causing a considerable time lag between the injection of sodium hypochlorite and its confirmation by residual chlorine meter 14. As a result, the sodium hypochlorite concentration in raw water tank 11 may deviate from the target concentration. Also in terms of avoiding problems caused by such time lags, the adjustment of the amount of sodium hypochlorite to be injected is preferably performed based on the values detected by of flowmeters 12, 16, 17 (preferably, the integrated values over a predetermined period), as described in this embodiment.

Detecting the presence of residual chlorine by residual chlorine meter 14 means that not only the treated water flowing through supply line L2 but also the circulating water flowing through circulation line L3 contains sodium hypochlorite that was not fully consumed in the urea decomposition reaction. Therefore, when calculating the amount of sodium hypochlorite to be injected, the sodium hypochlorite contained in the circulating water can be considered, thereby reducing the amount of sodium hypochlorite to be injected compared to when it is not considered. In other words, the content of sodium hypochlorite in the circulating water may be calculated from the value detected by residual chlorine meter 14 (preferably, its moving average value over a predetermined period) to calculate (correct) the amount of sodium hypochlorite to be injected by subtracting that content from the target amount to be injected described above. However, if the circulating water contains not only sodium hypochlorite but also sodium hypobromite, the value detected by residual chlorine meter 14 will also include the residual bromine concentration, which means that even if the value detected by residual chlorine meter 14 is simply used, the content of sodium hypochlorite in the circulating water may not be accurately calculated. Therefore, to eliminate the influence of such residual bromine concentration, the value detected by residual chlorine meter 14 may be corrected by a known method to calculate the content of sodium hypochlorite in the circulating water using the corrected value.

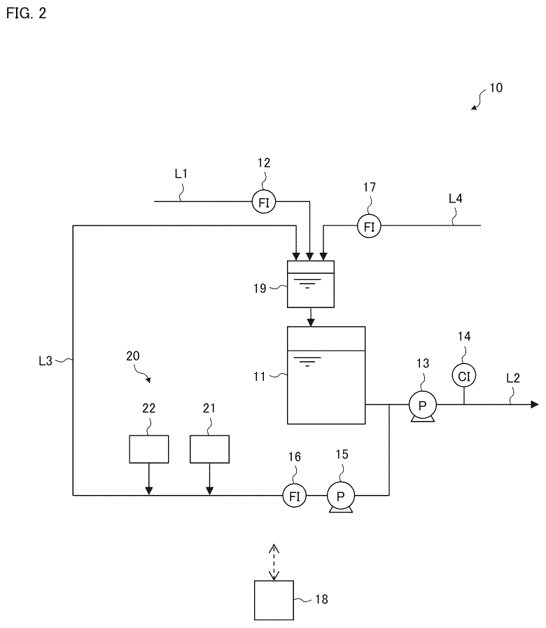

In the above-described embodiment, of the water to be treated flowing into raw water tank 11 through three lines L1, L3, L4, the chemicals are injected only into the circulating water flowing through circulating line L3. This may cause poor mixing of the chemicals contained in the circulating water with the other water to be treated, resulting in uneven chemical concentrations in raw water tank 11. To address this concern, sub-tank 19 may be provided between raw water tank 11 and three lines L1, L3, L4, as shown in FIG. 2. Sub-tank 19 functions as a mixing tank for temporarily storing the water to be treated, which is to be stored in raw water tank 11, to be mixed with the chemicals. Thus, the water to be treated can flow into raw water tank 11 after being thoroughly mixed with the chemicals, thereby preventing unevenness of the chemical concentrations in raw water tank 11. When raw water containing a large amount of silica is treated, the components contained in the chemicals may react with the silica in the raw water, causing scaling in circulation line L3 where the chemicals are injected. In such a case, the capacity of circulation pump 15 may be increased to increase the flow rate of the circulating water flowing through circulation line L3, but alternatively, the location where the chemicals are injected may be changed from circulation line L3 to sub-tank 19.

### Second Embodiment

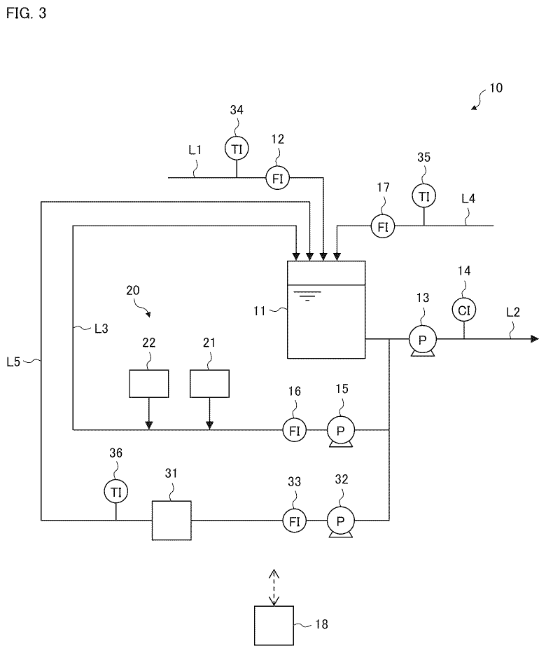

FIG. 3 is a schematic diagram of a water treatment apparatus according to a second embodiment of the present invention. Hereinafter, components identical to those of the first embodiment will be denoted by the same reference numerals in the drawings, description thereof will be omitted, and only components that are different from those of the first embodiment will be described.

It is known that the decomposition reaction of urea with chlorine-based oxidizing agents and bromide salts is accelerated at higher temperatures. Therefore, in this embodiment, a mechanism for heating the water to be treated in raw water tank 11 is provided. Specifically, in addition to circulation line (first circulation line) L3 of the first embodiment, another circulation line (second circulation line) L5 is provided parallel thereto, and second circulation line L5 is provided with heat exchanger 31. Second circulation line L5, like first circulation line L3, functions as the second inflow channel for allowing the water to be treated in raw water tank 11 to flow out and to flow again into raw water tank 11. Heat exchanger 31 functions as a heater that heats the water to be treated flowing into raw water tank 11 through second circulation line L5. Second circulation line L5 is also provided with second circulation pump 32 and second circulating water flowmeter 33. Second circulation pump 32 functions to allow the water to be treated in raw water tank 11 to flow through second circulation line L5, and includes an inverter (not shown) that controls its rotational speed. Second circulating water flowmeter 33 functions as a second flow detector that detects the flow rate of the water to be treated flowing into raw water tank 11 through second circulation line L5. Of the water to be treated in raw water tank 11, the water circulating through first circulation line L3 is also referred to as first circulating water, and the water circulating in second circulation line L5 is also referred to as second circulating water.

With this configuration, the water to be treated in raw water tank 11 can be kept at a certain temperature or higher to maintain the reaction rate of the urea decomposition reaction high, but from the perspective of energy conservation and cost reduction, it is not preferable when the temperature is too high. Therefore, in this embodiment, controller 18 performs temperature control to adjust the water to be treated in raw water tank 11 to the desired target temperature. For this purpose, water treatment apparatus 10 includes raw water thermometer 34 installed in raw water line L1, return water thermometer 35 installed in return line L4, and circulating water thermometer 36 installed in second circulation line L5. Raw water thermometer 34 functions as a first temperature detector that detects the temperature of the water to be treated flowing into raw water tank 11 through raw water line L1, and return water thermometer 35 functions as the first temperature detector that detects the temperature of the water to be treated flowing into raw water tank 11 through return line L4. On the other hand, circulating water thermometer 36 functions as a second temperature detector that detects the temperature of the water to be treated flowing into raw water tank 11 through return line L4.

In the meantime, because of the relatively long residence time of the water to be treated in raw water tank 11 as described above, when the raw water, return water, and second circulating water flow into raw water tank 11 at different temperatures, they are mixed and maintained at a constant temperature. The temperature in this case, Tₜₐₙₖ, is believed to be given by Equation (4) as below.

$${T}_{t a n k} = ( {Q}_{1} \times {T}_{1} + {Q}_{2} \times {T}_{2} + {Q}_{3} \times {T}_{3 )} / ( {Q}_{1} + {Q}_{2} + {Q}_{3} ) , \qquad ( 4 )$$

where Q₁, Q₂, and Q₃ are the flow rates of the raw water, return water, and second circulating water, respectively, and T₁, T₂, and T₃ are the temperatures of the raw water, return water, and second circulating water, respectively.

Therefore, the temperature control of the water to be treated by controller 18 is performed as described below. As a precondition, the set temperature of the water to be treated in raw water tank 11 has been stored in controller 18. The set temperature in this case does not need to be very high, and is, for example, 20-25° C. The amount of heating of the second circulating water by heat exchanger 31 is adjusted based on the detection results from flowmeters 12, 17, 33, the detection results from thermometers 34-36, and the predetermined set temperature of the water to be treated. Specifically, Equation (4) described above is first used to calculate the target temperature of the second circulating water (T₃) from the values detected by flowmeters 12, 17, 33 (Q₁, Q₂, Q₃), the values detected by raw water thermometer 34 and return water thermometer 35 (T₁, T₂), and the set temperature of the water to be treated (T). Once the target temperature is thus calculated, the amount of heating of the second circulating water by heat exchanger 31 is adjusted so that the temperature of the second circulating water detected by circulating water thermometer 36 reaches that target temperature.

Since Equation (4) described above is based on the assumption that the flow rates and temperature are constant, if, for example, large flow fluctuations (including flow stoppages) occur in the raw water flowing through raw water line L1, an appropriate value may not be obtained as the target temperature of the second circulating water. Therefore, to achieve stable temperature control of the water to be treated, the target temperature of the second circulating water is preferably calculated, once in a predetermined period, based on the integrated flow rates and average temperature over that predetermined period, as in the case of calculating the amounts of chemicals to be injected. For the same reason, the flow rate of the second circulating water is preferably adjusted to a predetermined flow rate, and for this purpose, second circulating pump 32 may be inverter controlled.

The location of heat exchanger 31 is not limited to second circulation line L5, but may be, for example, raw water line L1. In other words, the raw water flowing into raw water tank 11 through raw water line L1 may be heated to adjust the water to be treated in raw water tank 11 to a set temperature. However, because of the relatively long residence time of the water to be treated in raw water tank 11 as described above, if the temperature of the water to be treated drops while it remains in raw water tank 11, simply heating the raw water flowing into raw water tank 11 cannot counteract such a temperature drop. Further, if the pressure or flow rate of the raw water flowing through raw water line L1 becomes unstable, it becomes difficult to heat the raw water itself stably. From this perspective, heat exchanger 31 is preferably installed in second circulation line L5 as illustrated, i.e., adapted to heat the second circulating water.

On the other hand, since the number of circulation pumps increases compared to the first embodiment, considering manufacturing costs, heat exchanger 31 could be installed in first circulation line L3 instead of adding second circulation line L5 to install heat exchanger 31 therein. However, for example, in summer when the ambient temperature is high, there is no need to control the temperature of the water to be treated, nor is there any need to circulate the water to be treated for heating. Therefore, in this embodiment, although second circulating water pump 32 with a large capacity must be used to provide sufficient heat to the water to be treated, it is not necessary to run it constantly, and the increase in running costs is minimized. In contrast, if heat exchanger 31 is installed in first circulation line L3, not only must first circulation pump 15 with a similarly large capacity be used for heating, but it is also necessary to run it constantly for the chemical injection. Therefore, considering even the running costs of the circulation pumps, heat exchanger 31 is preferably installed in second circulation line L5 separate from first circulation line L3, as illustrated. In the illustrated example, first circulation line L3 and second circulation line L5 are provided independently of each other, but they may merge downstream to be connected to raw water tank 11.

The method of calculating the respective amounts of chemicals to be injected in this embodiment is the same as in the first embodiment, except that the sum of the values detected by first circulating water flowmeter 16 and second circulating water flowmeter 33 is used instead of the value detected by first circulating water flowmeter 16.

### REFERENCE SIGNS LIST

10 Water treatment apparatus
11 Raw water tank
12 Raw water flowmeter
13 Water pump
14 Residual chlorine meter
15 Circulation pump (First circulation pump)
16 Circulating water flowmeter (First circulating water flowmeter)
17 Return water flowmeter
18 Controller
19 Sub-tank
20 Chemical injector
21 Oxidizing agent injector
22 Bromide salt injector
31 Heat exchanger
32 Second circulation pump
33 Second circulating water flowmeter
34 Raw water thermometer
35 Return water temperature meter
36 Circulating water thermometer
L1 Raw water line
L2 Supply line
L3 Circulation line (First circulation line)
L4 Return line
L5 Second circulation line

1. A water treatment apparatus comprising:
a treatment tank for storing water to be treated;
a plurality of inflow channels for allowing the water to be treated to flow into the treatment tank;
a chemical injector that injects a chemical including a chlorine-based oxidizing agent and a bromide salt into the water to be treated flowing into the treatment tank through one inflow channel of the plurality of inflow channels to decompose urea contained in the water to be treated in the treatment tank;
a plurality of flow detectors that detect flow rates of the water to be treated flowing into the treatment tank through the plurality of inflow channels; and
a controller that adjusts an amount of the chemical to be injected into the water to be treated by the chemical injector based on detection results from the plurality of flow detectors and a target concentration of the chemical in the treatment tank.

2. The water treatment apparatus according to claim 1, wherein the controller calculates the amount of the chemical to be injected in a next predetermined period based on integrated flow rates over a predetermined period detected by the plurality of flow detectors and the target concentration.

3. The water treatment apparatus according to claim 1, wherein the plurality of inflow channels includes a first inflow channel for allowing the water to be treated to flow into the treatment tank from an outside and a second inflow channel for allowing the water to be treated in the treatment tank to flow out and to flow again into the treatment tank,
wherein the plurality of flow detectors includes a first flow detector that detects a flow rate of the water to be treated flowing into the treatment tank through the first inflow channel and a second flow detector that detects a flow rate of the water to be treated flowing into the treatment tank through the second inflow channel, and
wherein the chemical injector continuously injects the chemical into the water to be treated flowing through the second inflow channel.

4. The water treatment apparatus according to claim 3, wherein the controller calculates the amount of the chemical to be injected in a next predetermined period based on an integrated flow rate over a predetermined period detected by the first flow detector, an integrated flow rate over the predetermined period detected by the second flow detector, and the target concentration.

5. The water treatment apparatus according to claim 4, comprising a concentration detector that detects a residual chlorine concentration of treated water flowing out of the treatment tank,
wherein the controller corrects the calculated amount to be injected based on an average concentration over the predetermined period detected by the concentration detector.

6. The water treatment apparatus according to claim 3, comprising:
a heater that heats the water to be treated flowing into the treatment tank through the second inflow channel;
a first temperature detector that detects a temperature of the water to be treated flowing into the treatment tank through the first inflow channel; and
a second temperature detector that detects a temperature of the water to be treated flowing into the treatment tank through the second inflow channel,
wherein the controller adjusts an amount of heating of the water to be treated by the heater based on detection results from the first and second flow detectors, detection results from the first and second temperature detectors, and a set temperature of the water to be treated in the treatment tank.

7. The water treatment apparatus according to claim 6, wherein the controller calculates a target temperature based on an integrated flow rate over a predetermined period detected by the first flow detector, an integrated flow rate over the predetermined period detected by the second flow detector, an average temperature over the predetermined period detected by the first temperature detector, and the set temperature, and adjusts the amount of heating of the water to be treated based on the calculated target temperature and a value detected by the second temperature detector.

8. The water treatment apparatus according to claim 1, comprising a mixing tank provided between the treatment tank and the plurality of inflow channels for temporarily storing the water to be treated, which is to be stored in the treatment tank, to be mixed with the chemical.

9. A water treatment method comprising:
allowing water to be treated to flow into a treatment tank through a plurality of inflow channels; and
injecting a chemical including a bromide salt and a chlorine-based oxidizing agent into the water to be treated flowing into the treatment tank through one inflow channel of the plurality of inflow channels to decompose urea contained in the water to be treated in the treatment tank,
wherein the injecting comprises:
detecting flow rates of the water to be treated flowing into the treatment tank through the plurality of inflow channels; and
adjusting an amount of the chemical to be injected into the water to be treated based on the detected flow rates and a target concentration of the chemical in the treatment tank.
